(19) United States
(12) Patent Application Publication
(10) Pub. No.: US 2026/0276378 A1
(43) Pub. Date: Sep. 17, 2026

(54) DETERMINATION OF ALTITUDE OF ACCESS POINT

(71) Applicant: HEWLETT PACKARD ENTERPRISE DEVELOPMENT LP, Spring, TX (US)

(72) Inventors: Junpeng Wu, Beijing (CN); Jialong Niu, Beijing (CN); Xiumeng Wang, Beijing (CN); Zhonglin Feng, Beijing (CN); Yiting Zheng, Beijing (CN); Decai Peng, Beijing (CN)

(21) Appl. No.: 19/079,264

(22) Filed: Mar. 13, 2025

(51) Int. Cl. G01C 5/06

(52) U.S. Cl. CPC G01C 5/06

(57) ABSTRACT

In implementations of the present disclosure, a solution for determining an altitude of an access point (AP) is provided. The AP may obtain an air pressure, a location, a temperature and a humidity associated with the AP. The AP may further calibrate a gravitational acceleration at the AP based on a gravitational acceleration on an equatorial surface and the location, calibrate a Molar mass of air at the AP based on the humidity, and the temperature, and calibrate the temperature associated with the AP based on a temperature at sea level and the location. The AP may determine an altitude of the AP based on the calibrated gravitational acceleration at the AP, the calibrated Molar mass of air at the AP, the calibrated temperature associated with the AP, and the air pressure associated with the AP.

### BACKGROUND

An access point (AP) is a networking device that enables wireless local area network (WLAN) connectivity for Wi-Fi-enabled devices such as laptops, smartphones, and IoT devices. Advanced APs may also provide Bluetooth Low Energy (BLE) and/or Zigbee wireless connectivity. To meet the growing demand for wireless connectivity, APs have been designed to provide Wi-Fi for users and Internet of Things (IoT) devices across a range of environments and locations: indoors, remote, outdoors, and hazardous environments. Advances in Wi-Fi standards (for example, Wi-Fi 7) have evolved to address the growth in mobility and IoT, bandwidth demands of applications, and business requirements for high-performance, reliable, and secure wireless.

APs provide network access connectivity using radio technology rather than wired network cabling. This eliminates the cost and complexity of installing dedicated wired network cabling to users and devices and allows users and devices to remain wirelessly connected when mobile. As many business technologies increasingly rely on IP-based communication, they can leverage the network as a transport medium, which further reduces or eliminates physical overlays.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example network environment in which example implementations of the present disclosure may be implemented;

FIG. 2 illustrates an example block diagram in which example implementations of the present disclosure may be implemented;

FIG. 3 illustrates an example diagram for fine-tune calculation of an altitude of an AP according to implementations of the present disclosure;

FIG. 4 illustrates an example diagram of the air pressure and the temperature in a day according to implementations of the present disclosure;

FIG. 5 illustrates an example diagram of the air pressure, the humidity, and the temperature in a year according to implementations of the present disclosure;

FIG. 6 illustrates an example flow chart of an example method for determining an altitude of an AP according to implementations of the present disclosure; and

FIG. 7 illustrates an example AP according to implementations of the present disclosure.

### DETAILED DESCRIPTION

Automated Frequency Coordination (AFC) is a system designed to coordinate the use of the radio spectrum. The system for AFC may comprise a database which records the frequency bands in use by a variety of radio frequency services within a specific geographic area. If an AP wants to obtain the AFC response with allowed frequency bands from the AFC vendor, the AP may report its location (for example, via Frequency Coordination Orchestrator, FCO) in a manner of Global Positioning System (GPS) data. The FCO service may also require an AP's altitude in an AFC request. Further, the location service for managing the deployment of APs in a facility may also need the sea level altitude and ground level altitude of the APs. The location service may also want to obtain the altitude differences of different APs.

However, traditionally, the location of an AP may be obtained from, for example, a GPS chip mounted on the AP. Usually, the GPS chip may determine an inaccurate altitude compared with the latitude and the longitude. Further, in the case that the AP is situated indoors, the GPS signals are very weak or even non-existent. Therefore, a barometric pressure sensor is introduced to the AP to calculate the AP's altitude without using GPS. However, by using barometric pressure, the calculated altitude usually varies frequently over one day. The calculated altitude is very rough. Hence, there is a need to improve the traditional way of calculating the AP's altitude based on the barometric pressure for APs, especially for indoor APs.

Therefore, implementations of the present disclosure propose a solution for determining an altitude of an AP based on a barometric pressure. Generally, the AP may obtain an air pressure associated with the AP, a location associated with the AP, a temperature associated with the AP, and a humidity associated with the AP. The AP may further calibrate a gravitational acceleration at the AP based on a gravitational acceleration on an equatorial surface and the location associated with the AP. The AP may further calibrate a Molar mass of air at the AP based on the humidity and the temperature associated with the AP. The AP may further calibrate the temperature associated with the AP based on a temperature at sea level and the location of the AP. Finally, the AP may determine an altitude of the AP based on the calibrated gravitational acceleration at the AP, the calibrated Molar mass of air at the AP, the calibrated temperature associated with the AP, and the air pressure associated with the AP.

According to implementations of the present disclosure, a more accurate altitude of the AP can be determined. For example, the calculation of the AP's altitude can be optimized by calibrating the parameters used in the International Standard Atmosphere (ISA) model, such as the gravitational acceleration, the average molar mass of air and the standard temperature at sea level.

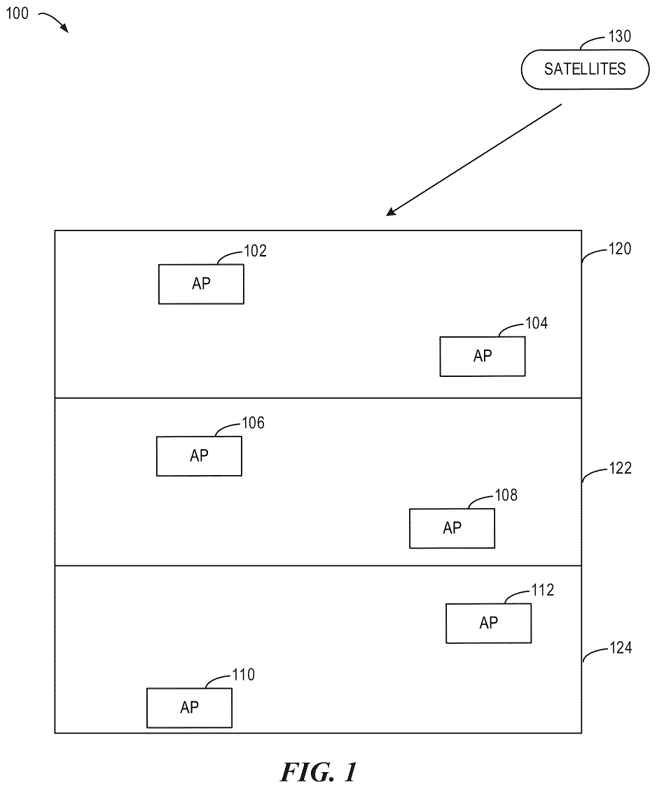

The advantages of implementations of the present disclosure will be described with reference to example implementations as described below. Reference is made below to FIG. 1 through FIG. 7 to illustrate basic principles and several example implementations of the present disclosure herein.

Reference is made to FIG. 1, which illustrates an example network environment 100 in which example implementations of the present disclosure may be implemented. As shown in FIG. 1, the network environment 100 may comprise a building with three floors. There deployed some APs on each floor. It is to be understood that this is a non-exclusive example without limitations. There may be more floors in a building and/or more APs on each floor. Alternatively, there may be fewer floors in a building and/or fewer APs on each floor.

The APs on each floor may be deployment in the same or different location. As an example, on the first floor 124, an AP 110 may be deployed on a rack which is close to the floor, and an AP 112 may be deployed on a rack which is close to the roof. On the second floor 122, an AP 108 may be deployed on a rack which is close to the floor, and an AP 106 may be deployed on a rack which is close to the roof. In the third floor 120, an AP 104 may be deployed on a rack which is close to the floor, and an AP 102 may be deployed on a rack which is close to the roof.

There may be some satellites in the space, which may be collectively referred to as the satellites 130. The satellites 130 may send GPS signals to the AP 102 to the AP 112. The AP 102 to the AP 112 may obtain their locations (in the manner of longitudes, latitudes, and altitudes) via GPS chips. Usually, the latitude and the longitude are more accurate than the altitude. The AP 102 to the AP 112 may also comprise a barometric pressure sensor which can measure the air pressure to calculate the AP's air pressure altitude without using GPS.

A management software for managing and configuring the deployed AP 102 to the AP 112 in this building may provide a location service. By using the location service, the AP 102 to the AP 112 can be visualized. For example, the locations of the AP 102 to the AP 112 can be visualized in a landscape view. The AP 102 to the AP 112 may also be divided into groups based on different floors. The AP 102 to the AP 112 may also report their location in the AFC request to the FCO service to obtain AFC responses with allowed frequency bands.

Further, it is to be understood that the number of APs, the number of floors, and the number of buildings are not limited to what they are shown in FIG. 1. The layout and arrangement of the APs are not limited to what they are shown in FIG. 1. It is to be understood that for the purposed of simplification, the term “altitude” and the term “height” may be used interchangeably throughout the present disclosure.

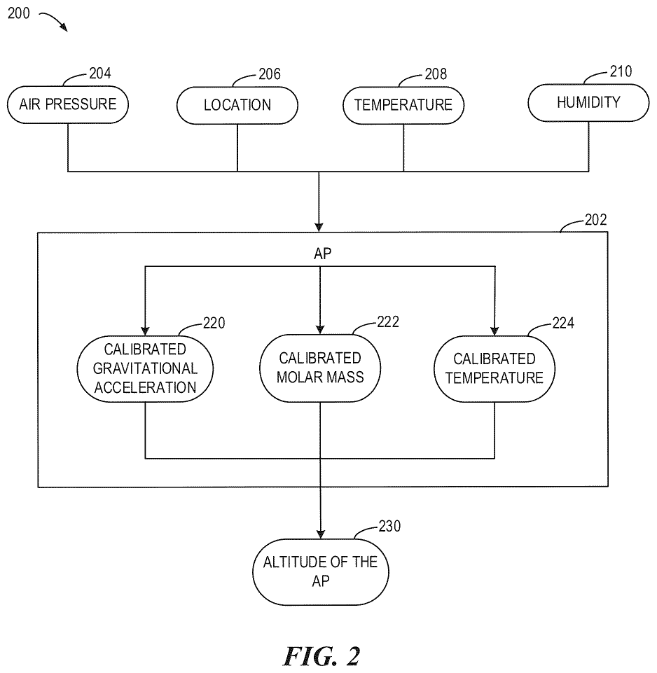

Reference is made to FIG. 2, which illustrates an example block diagram 200 in which example implementations of the present disclosure may be implemented. As shown in FIG. 2, an AP 202 may comprise a GPS chip, a barometric pressure sensor, a humidity sensor, and/or a temperature sensor. Alternatively, AP 202 may be attached to a GPS sensor, a barometric pressure sensor, a humidity sensor, and/or a temperature sensor. The difference is that these sensors can be seen as a portion of the AP 202 or not. Alternatively, the AP 202 may obtain the humidity value and/or the temperature from a server, for example, from a meteorological bureau or internet weather website, so that the AP 202 does not need to have the humidity sensor and/or the temperature sensor.

The AP 202 may obtain an air pressure 204 from the barometric pressure sensor. The air pressure 204 may be considered as the air pressure at the AP 202 because the barometric pressure sensor is a portion of the AP 202 or the barometric pressure sensor is attached very closely to the AP 202. The AP 202 may obtain a location 206 from a GPS chip. The location 206 may be considered as the location of the AP 202 because a GPS receiver connected to the GPS chip is a portion of the AP 202 or the GPS receiver is attached very closely to the AP 202.

The AP 202 may obtain a temperature 208 from the temperature sensor. The temperature 208 may be considered as the temperature at the AP 202 because the temperature sensor is a portion of the AP 202 or the temperature sensor is attached very closely to the AP 202. The AP 202 may obtain a humidity 210 from the humidity sensor. The humidity 210 may be considered as the humidity at the AP 202 because the humidity sensor is a portion of the AP 202 or the humidity sensor is attached very closely to the AP 202. Further, in some example implementations, the AP 202 may obtain a temperature at sea level from a server, for example, from a meteorological bureau or internet weather website.

After obtaining the air pressure 204, the location 206, the temperature 208, the humidity 210, and/or the temperature at sea level, the AP 202 may calculate its altitude 230 using the ISA model. For example, the AP 202 may update the parameters used in the ISA model to determine a more accurate altitude 230 of the AP 202. Examples of parameters may be the gravitational acceleration, the average molar mass of air, and the standard temperature at sea level.

The ISA model is chosen for determining the altitude 230 of the AP 202 because the AP 202 is in the troposphere layer, and thus the air pressure 204 varies with altitude. Therefore, the barometric pressure sensor can be used to provide the altitude of the AP 202, which is called the air pressure altitude.

A standard ISA model may be expressed as equation (1):

$$h = \frac{{T}_{0}}{L} [ {( \frac{{P}_{0}}{P} )}^{\frac{RL}{gM}} - 1 ] \qquad ( 1 )$$

where h may represent the altitude; P may represent the air pressure at altitude h; P₀ may represent the standard atmospheric pressure (or air pressure) at sea level (101325 Pa); L may represent the temperature gradient (−0.0065 K/m); T₀ may represent the standard temperature at sea level (288.15 K); g may represent the average gravitational acceleration (9.80665 m/s²); M may represent the average molar mass of air (0.0289644 kg/mol); and R may represent the gas constant (8.3144598 J/(mol K)).

In some example implementations, in equation (1), the calculation result is the altitude h. P may be obtained from AP 202. P₀, L, T₀, g, M and R are default numerical values.

In some example implementations, one or more of the parameters in the ISA model need to be calibrated to obtain more a accurate altitude 230 of the AP 202. For example, calibrating g (gravitational acceleration), M (average molar mass of air), and T₀ (standard temperature at sea level).

In some example implementations, the relationship between the gravitational acceleration and the altitude may be expressed as equation (2):

$$g ( h ) = {{g}_{0} ( \frac{{R}_{E}}{{R}_{E} + h} )}^{2} \qquad ( 2 )$$

where h may represent the altitude; g₀ may represent the gravitational acceleration on the equatorial surface, which is approximately 9.780327 m/s²; g(h) may represent the gravitational acceleration at altitude h; R_{E} may represent the average radius of the Earth, which is approximately 6371 km.

In some example implementations, the relationship between the gravitational acceleration and the latitude may be expressed as equation (3):

$$g ( φ ) = {g}_{0} ( 1 + {βsin}^{2} φ - {γsin}^{2} 2 φ ) \qquad ( 3 )$$

where g₀ may represent the gravitational acceleration on the equatorial surface, which is approximately 9.780327 m/s²; g(φ) may represent the gravitational acceleration at latitude φ; β and φ represent the constants related to the shape and rotation of the Earth, in which β≈0.0053024 and φ≈0.0000059.

Consequently, in some example implementations, considering the changes in the altitude and the latitude comprehensively, the gravitational acceleration at altitude h and latitude φ may be expressed as equation (4):

$$g ( h , φ ) \approx {{g}_{0} ( \frac{{R}_{E}}{{R}_{E} + h} )}^{2} ( 1 + {βsin}^{2} φ - {γsin}^{2} 2 φ ) \qquad ( 4 )$$

where g(h,φ) may represent the gravitational acceleration at altitude h and latitude φ.

Therefore, the AP 202 may use the equation (4) to calibrate the location 206 to obtain the calibrated gravitational acceleration 220. The average gravitational acceleration (9.80665 m/s²) used in the ISA model may be updated with the gravitational acceleration at altitude h and latitude φ, i.e., the calibrated gravitational acceleration 220 at AP 202.

In some example implementations, the average Molar mass of air at altitude h may be expressed as equation (5):

$${M}_{a} = {M}_{b} \frac{( 1 - AH )}{1000} + {M}_{w} \frac{AH}{1000} \qquad ( 5 )$$

where Mₐ may represent the average Molar mass of air at altitude h; M_{b} may represent the dry air molecules (average Molar mass 28.97 g/mol); M_{w} may represent the water molecules (Molar mass 18.016 g/mol); and AH may represent the absolute humidity.

In some example implementations, the relationship between the relative humidity and the absolute humidity equation (6):

$$H = \frac{RH \times {P}_{s}}{{R}_{w} \times T \times 100} \qquad ( 6 )$$

where RH may represent the relative humidity (for example, the humidity 208); Pₛ may represent the saturation vapor pressure, measured in pascal (Pa); R_{w} may represent the specific gas constant for water vapor, which is 461.5 J/(kg K); and T may represent the temperature, measured in kelvin (K).

In some example implementations, to obtain the saturation vapor pressure more accurately, equation (7) and equation (8) may be used for calculating the saturation vapor pressure of water:
when T>0° C.,

$${P}_{s} = \frac{exp ( 34.494 - \frac{4924.99}{T + 237.1} )}{{( T + 105 )}^{1.57}}$$

$$when T \leq 0 ° C .$$

$${P}_{s} = \frac{exp ( 43.494 - \frac{6545.8}{T + 278} )}{{( T + 868 )}^{1.57}} \qquad ( 8 )$$

Where Pₛ may represent the saturation vapor pressure; and T may represent the temperature.

Equations (7) and (8) may be used for the calculation of the saturation vapor pressure. After the saturation vapor pressure is calculated, equation (6) may be used to obtain the absolute humidity. After the absolute humidity is obtained, equation (5) may be used to calibrate the average Molar mass of air. That is, the calibrated Molar mass 222 of air may be updated with the value of the average molar mass of air at altitude h (i.e., Mₐ).

In some example implementations, the temperature at sea level is hard to be obtained, the temperature gradients may be used to convert sea level temperature into temperature at altitude h, which may be expressed as equation (9):

$$T = {T}_{0} + Lh \qquad ( 9 )$$

where T may represent the temperature at altitude h (i.e., the calibrated temperature 224); T₀ may represent the temperature at sea level; h may represent the altitude; and L may represent the temperature gradient (−0.0065 K/m).

In some example implementations, equations (4), (5) and (9) can be substituted into equation (1) to obtain equation (10):

$$h = \frac{T}{L} [ 1 - {( \frac{P}{{P}_{0}} )}^{\frac{RL}{g ( h , φ ) \cdot {M}_{a}}} ] \qquad ( 10 )$$

where h may represent the altitude at AP 202; P may represent the air pressure at altitude h; P₀ may represent the atmospheric pressure at sea level; P may represent the air pressure at altitude h; T may represent the temperature at altitude h; g(h,φ) may represent the gravitational acceleration at altitude h and latitude φ; Mₐ may represent the average Molar mass of air; L may represent the temperature gradient (−0.0065 K/m); and R may represent the gas constant (8.3144598 J/(mol K)).

In some example implementations, in equation (10), the calculation result is the altitude h (i.e., the altitude 230 of the AP 202). P may be obtained from AP 202. T may be obtained from AP 202. P₀ may be obtained from a server, for example, from a meteorological bureau or internet weather website. g(h,φ) may be obtained from the equation (4). Mₐ may be obtained from the equation (5). L and R are default numerical values.

By using equation (10), a more accurate altitude 230 of AP 202 can be obtained because a more accurate gravitational acceleration, a more accurate Molar mass of air and a more accurate temperature are used. It is to be understood that the altitude 230 is relative to the sea level. Therefore, in some example implementations, if the height of the AP 202 from the ground is intended, it needs to replace P₀ (atmospheric pressure at sea level) with the ground air pressure.

In some example implementations, the height difference (or also referred to as the altitude difference) between different APs may be intended such that the APs can be accurately divided into different groups. With the air pressure sensor associated with each AP, the height distance between APs can be accurately calculated through the air pressure and solving the problem of AP floor distribution. For example, the height between AP a and AP b (AP a and AP b are two APs located on different floors) can be calculated based on the equation (11) of the ISA model and the air pressure difference obtained by AP a and AP b:

$$Δ h = \frac{T}{L} [ 1 - {( \frac{{P}_{a}}{{P}_{b}} )}^{\frac{RL}{g ( h , φ ) \cdot {M}_{a}}} ] \qquad ( 11 )$$

where Δh may represent the height distance between AP a and AP b; Pₐ may represent the air pressure at altitude ha; P_{b} may represent the air pressure at altitude hb; T may represent the temperature at altitude hb; g(h,φ) may represent the gravitational acceleration at altitude hb and latitude φ; Mₐ may represent the average Molar mass of air; L may represent the temperature gradient (−0.0065 K/m); and R may represent the gas constant (8.3144598 J/(mol K)).

By using equation (11), the height distance between AP a and AP b can be determined. Pₐ may be obtained from AP a. P_{b} may be obtained from AP b. T may be obtained from AP b. g(h,φ) may be obtained from the equation (4). Mₐ may be obtained from the equation (5). L and R are default numerical values.

In some example implementations, the default numerical values L and R may be optimized. For example, L and R may be optimized by the height distances between APs and the equation (11). As an example, the height distances between APs may be obtained by input from a client via a knob which allows the customer to input the APs' ground levels, and then the height difference between two APs can be obtained.

In some example implementations, a fine timing measurement (FTM) equation may be used to optimize the default numerical values L and R. For example, the straight-line distance between two APs can be obtained through the FTM equation, and then the height difference between two APs can be calculated based on the spatial geometry between multiple APs.

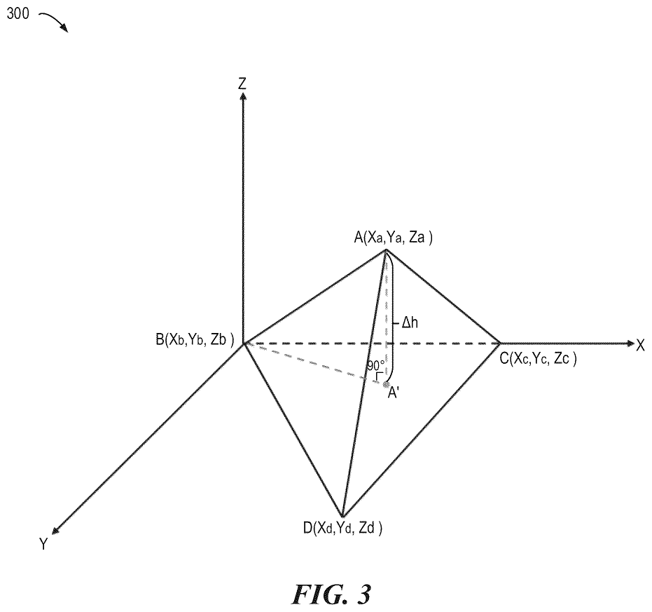

Reference is made to FIG. 3, which illustrates an example diagram 300 for fine-tune calculation of the altitude of an AP according to implementations of the present disclosure. FIG. 3 shows a mathematical model for determining the height difference between two APs (an AP at Point A and an AP at Point B). The basic idea is that there are two horizontal planes, and one plane comprises a Point A, and the other plane comprises three points, Point B, Point C, and Point D. If the distances between each two points are known, then the distance between the two planes can be calculated.

As shown in FIG. 3, there is an AP at Point A, an AP at Point B, an AP at Point C, and an AP at Point D. Point B may be placed at the origin of the XYZ coordinate system, and the coordinates of Point B=(0, 0, 0). Point C may be placed at the X axis, and the coordinates of Point C=(BC, 0, 0), where BC may represent the distance between Point B and Point C.

Assuming the coordinates of Point D=(x_{d}, y_{d}, 0), there are an equation set (12):

$$( \begin{matrix}{x}_{d}^{2} + {y}_{d}^{2} = {BD}^{2} \\ {( {x}_{d} - BC )}^{2} + {y}_{d}^{2} = {CD}^{2}\end{matrix} ) \qquad ( 12 )$$

where BD may represent the distance between Point B and Point D; and CD may represent the distance between Point C and Point D.

According to the equation set (12) and based on Point B and Point C, the position of D on the X axis (x_{d}) may be calculated. Further, the two symmetrical coordinates on the Y axis may be calculated. For example, there may be two positions of Point D on the Y axis, which are a position in the positive direction and a position in the negative direction. These two points may be called “two symmetry coordinates”. The positive or negative values of the two symmetrical coordinates on the Y axis are only for one plane, and no exact values are needed to be known. Assuming the coordinates of Point A=(xₐ, yₐ, zₐ), there are an equation set (13):

$$( \begin{matrix}{x}_{a}^{2} + {y}_{a}^{2} + {z}_{a}^{2} = {BA}^{2} \\ {( {x}_{a} - BC )}^{2} + {y}_{a}^{2} + {z}_{a}^{2} = {CA}^{2}\end{matrix} ) \qquad ( 13 )$$

where BA may represent the distance between Point B and Point A; and CA may represent the distance between Point C and Point A. Based on Point B and Point C, the position of Point A on the X axis (xₐ) may be calculated.

Based on the position of Point A on the X axis (xₐ), Point B, and Point D, and according to an equation set (14), the position of A on the Y axis (yₐ) may be calculated:

$$( \begin{matrix}{x}_{a}^{2} + {y}_{a}^{2} + {z}_{a}^{2} = {BA}^{2} \\ {( {x}_{a} - {x}_{d} )}^{2} + {( {y}_{a} - {y}_{d} )}^{2} + {z}_{a}^{2} = {DA}^{2}\end{matrix} ) \qquad ( 14 )$$

where DA may represent the distance between Point D and Point A.

Based on the position of X axis coordinate of the Point A (xₐ), the position of Y axis coordinate of Point A (yₐ), and Point B, the position of Point A on the Z axis (zₐ) may be calculated by an equation set (15):

$$( {x}_{a}^{2} + {y}_{a}^{2} + {z}_{a}^{2} = {BA}^{2} ) \qquad ( 15 )$$

The position of Point A on the Z axis (zₐ) may be the vertical distance between two planes, for example, the vertical distance between Point A to the surface BCD. That is, the projection of A to the surface BCD may the point A′, and the distance between Point A to the surface BCD may be represented by AA′ (i.e., Δh). In this way, after calculating a certain amount of different sample points (i.e., the sample APs), the average value of the calculated height (Δh) of different sample APs may be used to improve and optimize the height difference between two APs.

In some example implementations, based on the more accurate height difference between two APs (for example, an AP 1 and an AP 2) and the air pressure of an AP of the two APs, the temperature gradient L may be optimized by an equation (16):

$$ln ( \frac{{P}_{2}}{{P}_{1}} ) = \frac{g ( h , φ ) \cdot {M}_{a}}{RL} ln ( 1 - \frac{L}{{T}_{1}} Δ h ) \qquad ( 16 )$$

where P₁ may represent the air pressure at height h₁ (i.e., at the AP 1); P₂ may represent the air pressure at height h₂ (i.e., at the AP 2); Δh may represent the height difference the AP 1 and the AP 2; T₁ may represent the temperature at height h₁ (i.e., at the AP 1); g(h,φ) may represent the gravitational acceleration at an average of (altitude h1+altitude h2) and latitude φ; Mₐ may represent the average Molar mass of air; and R may represent the gas constant (8.3144598 J/(mol K)).

By using equation (16), the temperature gradient L can be determined. Δh may be obtained from the AP 1 or the AP 2. P₁ may be obtained from AP 1. P₂ may be obtained from AP 2. T₁ may be obtained from AP 1. g(h,φ) may be obtained from the equation (4). Mₐ may be obtained from the equation (5). R may be the default numerical value.

In some example implementations, to solve the equation (16) to obtain the optimized temperature gradient L, some numerical iteration methods may be used, for example, the Newton iteration method. As an example, the equation (16) may be rearranged to an equation (17), which is suitable for solving L and defining the objective function and its derivatives:

$$F ( L ) = \frac{g ( h , φ ) \cdot {M}_{a}}{RL} ln ( 1 - \frac{L Δ h}{{T}_{1}} ) - ln ( \frac{{P}_{2}}{{P}_{1}} ) \qquad ( 17 )$$

where F(L) may represent the objective function for solving to obtain L.

The derivative of the equation (17) may be expressed as an equation (18):

$${F}^{′} ( L ) = - \frac{g ( h , φ ) \cdot {M}_{a}}{{RL}^{2}} ln ( 1 - \frac{L Δ h}{{T}_{1}} ) - \frac{g ( h , φ ) \cdot {M}_{a}}{{RL}^{2}} \cdot \frac{Δ h}{{T}_{1} - L Δ h} \qquad ( 18 )$$

By using the Newton iteration method, the equation (17) and the equation (18) can be solved and then the optimized temperature gradient L can be obtained. The optimized temperature gradient L is more suitable for the local area where the AP is located.

In some example implementations, from the equation (10), the equation (11) and equation (16), some parameters may be obtained from a server. For example, the temperature T, the atmospheric pressure P₀ at the sea level, and the relative humidity RH. The server may obtain data from the weather bureau and then push the data to the AP for calculating the altitude.

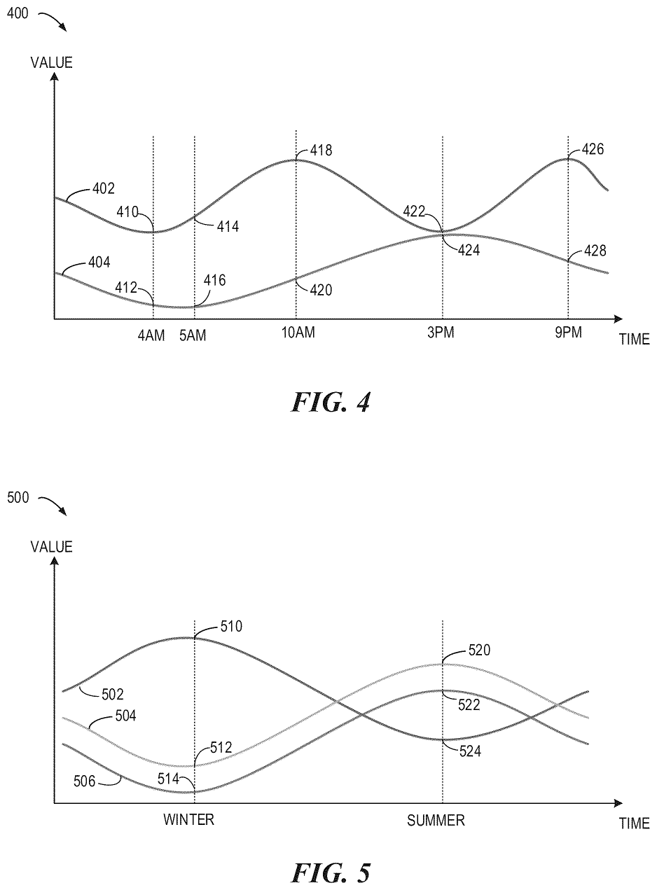

Reference is made to FIG. 4, which illustrates an example diagram 400 of the air pressure and the temperature in a day according to implementations of the present disclosure. As shown in FIG. 4, the curve 402 may represent the air pressure in a day. Point 410 may represent the air pressure at four in the morning. Point 414 may represent the air pressure at five in the morning. Point 418 may represent the air pressure at ten in the morning. Point 422 may represent the air pressure at three in the afternoon. Point 426 may represent the air pressure at nine at night.

The curve 404 may represent the temperature in a day. Point 412 may represent the temperature at four in the morning. Point 416 may represent the temperature at five in the morning. Point 420 may represent the temperature at ten in the morning. Point 424 may represent the temperature at three in the afternoon. Point 428 may represent the temperature at nine at night.

From FIG. 4, it can be seen that in a sunny and dry day, the temperature usually has one extremely high and one extremely low value, and the air pressure usually has two extremely high and two extremely low values. The daily fluctuation range of air pressure is usually around 2 or 3 hPa.

Reference is made to FIG. 5, which illustrates an example diagram 500 of the air pressure, the humidity, and the temperature in a year according to implementations of the present disclosure. As shown in FIG. 5, the curve 502 may represent the air pressure in a year. Point 510 may represent the air pressure in winter. Point 524 may represent the air pressure in summer. The curve 504 may represent the humidity in a year. Point 512 may represent the humidity in winter. Point 520 may represent the humidity in summer. The curve 506 may represent the temperature in a year. Point 514 may represent the temperature in winter. Point 522 may represent the temperature in summer.

From FIG. 4 and FIG. 5, it can be seen that the weather changes throughout a year, and even throughout a day, are very significant. Therefore, the impact of weather changes over time should be considered when determining the altitude of an AP based on the air pressure. These known influencing factors may be used to further optimize the algorithms for determining the altitude of an AP based on the air pressure.

Therefore, in some example implementations, the relationship between the altitude of an AP and the air pressure may be further optimized by a machine learning (ML) model. It is noticed that the weather factors (such as air pressure, temperature, humidity, and so on) are not constant. They not only change greatly with the season, but also have significant differences throughout a day. Therefore, these data have great reference value for training the ML model.

For example, a supervised learning problem may be set up to optimize the relationship between the altitude of an AP and the air pressure. In the supervised learning problem, the input features are the air pressure and the temperature, and the target variable is the height. As an illustrative example for training without limitations, sample dataset for training the supervised learning ML model may be collected. For example, the atmospheric data includes the pressure (P), the reference pressure (P₀), the temperature (T₀), and the height (h). The sample dataset may cover a wide range of altitudes and atmospheric conditions and/or throughout a year.

The sample dataset may be preprocessed. For example, to normalize or standardize the features based on the sample dataset, and Split the data into a training dataset and a testing dataset. The feature engineering may be performed. For example, to create the features based on one or more formulas. As an example, ln

$$( \frac{{P}_{0}}{{P}_{}} )$$

may be used as a feature.

Then, an ML model may be selected for training. Maybe starting with a simple model, i.e., a linear regression model. If the sample data has a big noise or the data pattern is more complex, a Ridge/Lasso regression model may be used instead of the linear regression model. If the data relationship pattern is not suitable for the linear regression model, a polynomial regression model or support vector regression (SVR) model with a non-linear kernel, or other more complex models such as the random forest model, the gradient boosting model, or the neural network model may be used instead of the linear regression model.

Next, the selected ML model may be trained based on the training dataset. The trained ML model may be evaluated on the testing dataset. For example, the metrics such as the Mean Squared Error (MSE) and/or R² score may be used to evaluate the trained ML model. Seventh, once the trained ML model is done, the gas constant R and the temperature gradient L may be estimated to be optimized. In some cases, it needs an iterative adjustment and validation of the gas constant R and the temperature gradient L, then the optimized R and L may be obtained to fit the ML model correctly.

In some example implementations, hereinafter is an example using Python with Scikit-learn:

| # Example dataset | |
|---|---|
| data = { | |
| ‘P0’: np.array([...]), | # reference pressure |
| ‘P’: np.array([...]), | # pressure |
| ‘T0’: np. array([...]), | # temperature |
| ‘h’: np.array([...]) | # height |

}
# Initialize and train the model
model = LinearRegression( )
# Evaluate the model
mse = mean_squared_error(test, pred)
# Get the estimated parameters
R_L = model.coef_[1]
L = model.intercept_{—}

In some example implementations, if the relationship between the input features (for example, the air pressure and the temperature) and the target variable (for example, the altitude of the AP) is approximately linear, a linear regression may be effective and interpretable. Therefore, through the linear regression model, the optimized R and L may be obtained.

In some example implementations, if there is still a significant deviation in the accuracy of the optimized R and L output by the linear regression model, further calibration and optimization may be performed using one or more non-linear ML models. For example, the polynomial regression model, the SVR model, the decision tree model, the gradient boosting machine model, and/or the neural network model.

The above-listed non-linear ML models are only illustrative, and they have different advantages. Therefore, they may be selected based on different data characteristics. For the polynomial regression model, if the relationship between the output and input is non-linear and can be represented by a polynomial, then polynomial regression may be suitable. For the SVR model, the SVR model has a non-linear kernel (like RBF) and thus can capture more complex relationships. For the decision tree model, if it is the random forests, it is good for capturing non-linear relationships and interactions between features, and it is also relatively robust to overfitting.

For the gradient boosting machine model (GBM), the GMB (such as the XGBoost, the LightGBM, and so on) may provide high accuracy and can handle complex data distributions well. For the neural network model, if the relationship between the output and input is highly complex, the neural network with one or more hidden layers may be appropriate. The neural network model can capture intricate patterns in the data but requires more data and computational resources. Therefore, depending on the different advantages provided by the different non-linear ML models, the R and L may be further optimized.

In some example implementations, the algorithm for optimizing the altitude of an AP may use the machine learning model operated on a server. Further, the server may collect different AP's height differences, and then optimize the parameters, and then push these optimized parameters to the AP for a more accurate calculation of the altitude.

In this way, the proposed method for optimizing the altitude of an AP involves many aspects, such as selecting appropriate formulas, considering the environmental factors, and the feedback optimization. Therefore, parameters such as g (gravitational acceleration), M (molar mass), and T (temperature) may be optimized at the formula level based on the ISA model. Therefore, a more accurate altitude (or height) and/or relative altitude (or height) can be obtained.

In some example implementations, reverse optimization for L (temperature gradient) through accurate h (altitude) and P (air pressure at altitude h) may performed. In some example implementations, a large amount of data and suitable machine learning algorithms are combined to continuously optimize R (gas constant) and L (temperature gradient). Hence, a much more accurate altitude (or height) and/or relative altitude (or height) can be obtained.

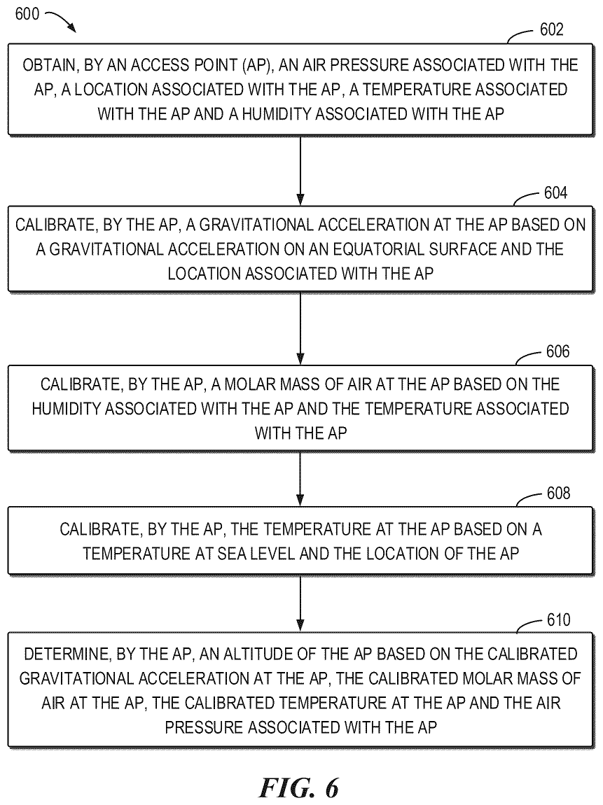

Reference is made to FIG. 6, which illustrates an example flow chart of an example method 600 for determining an altitude of an AP according to implementations of the present disclosure, and the method 600 may be performed by an AP such as the AP 202. For clarity, reference will be made in combination with FIG. 2.

At 602, the AP 202 determines obtains an air pressure associated with the AP 202, a location associated with the AP 202, a temperature associated with the AP 202, and a humidity associated with the AP 202. As an example, the AP 202 may obtain the air pressure 204, the location 206, the temperature 208, and the humidity 210 from a server or sensors.

At 604, the AP 202 calibrates a gravitational acceleration at the AP 202 based on a gravitational acceleration on an equatorial surface and the location associated with the AP 202. As an example, the AP 202 may calibrate the gravitational acceleration at the AP 202 to obtain the calibrated gravitational acceleration 220.

At 606, the AP 202 calibrates a Molar mass of air at the AP 202 based on the humidity associated with the AP 202 and the temperature associated with the AP 202. As an example, the AP 202 may calibrate the Molar mass of air at the AP 202 to obtain the calibrated Molar mass of air 222.

At 608, the AP 202 calibrates the temperature associated with the AP 202 based on a temperature at sea level and the location of the AP 202. As an example, the AP 202 may calibrate the temperature at the AP 202 to obtain the calibrated temperature 224.

At 610, the AP 202 determines an altitude of the AP 202 based on the calibrated gravitational acceleration 220 at the AP 202, the calibrated Molar mass of air 222 at the AP 202, the calibrated temperature 224 associated with the AP 202, and the air pressure 204 associated with the AP 202.

According to implementations of the present disclosure, a more accurate altitude of the AP can be determined. As an example, the calculation of the AP's altitude can be optimized by updating the gravitational acceleration, the average molar mass of air, and the standard temperature at sea level, thereby optimizing the calculation of the AP's altitude. The gravitational acceleration (with an average value of 9.80665 m/s²) used in the ISA model can be updated with the gravitational acceleration at the AP. The average molar mass of air (with an average value of 0.0289644 kg/mol) used in the ISA model can be updated with the molar mass of air at the AP. The temperature (with a value of a sea level temperature) used in the ISA model can be updated with the temperature associated with the AP. In this way, a more accurate altitude of the AP can be determined.

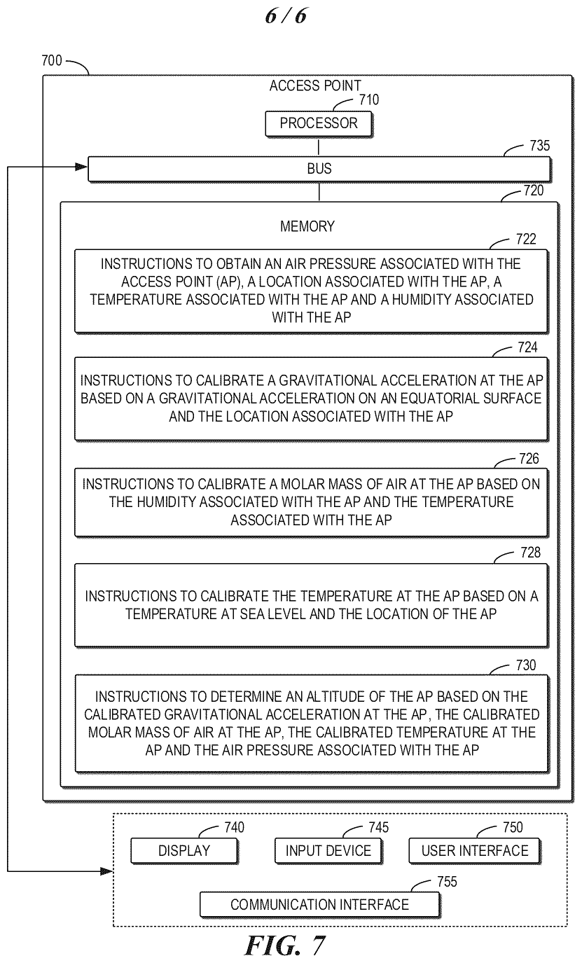

Reference is made to FIG. 7, which illustrates an example AP 700 according to implementations of the present disclosure. As shown in FIG. 7, the AP 700 comprises at least one processor 710, and a memory 720 coupled to the at least one processor 710 via a bus 735. The memory 720 stores instructions 722, 724, 726, 728, and 730 to cause the processor 710 to perform actions according to example implementations of the present disclosure. The AP 700 may further comprise or be connected to a display 740, an input device 745, a user interface 750, and/or a communication interface 755.

As shown in FIG. 7, the memory 720 stores instructions 722 to obtain an air pressure associated with the AP, a location associated with the AP, a temperature associated with the AP, and a humidity associated with the AP. The memory 720 further stores instructions 724 to calibrate a gravitational acceleration at the AP based on a gravitational acceleration on an equatorial surface and the location associated with the AP.

The memory 720 further stores instructions 726 to calibrate a Molar mass of air at the AP based on the humidity associated with the AP and the temperature associated with the AP. The memory 720 further stores instructions 728 to calibrate the temperature associated with the AP based on a temperature at sea level and the location of the AP. The memory 720 further stores instructions 730 to determine an altitude of the AP based on the calibrated gravitational acceleration at the AP, the calibrated Molar mass of air at the AP, the calibrated temperature associated with the AP and the air pressure associated with the AP. The stored instructions and the functions that the instructions may perform can be understood with reference to the description of FIGS. 1-6. For the purpose of simplification, the details of instructions 722, 724, 726, 728, and 730 will not be discussed herein.

Similarly, by implementing the instructions 722, 724, 726, 728, and 730, a more accurate altitude of the AP can be determined. Other advantages of implementations will not be discussed again for the sake of simplification.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
obtaining, by an access point (AP), an air pressure associated with the AP, a location associated with the AP, a temperature associated with the AP and a humidity associated with the AP;
calibrating, by the AP, a gravitational acceleration at the AP based on a gravitational acceleration on an equatorial surface and the location associated with the AP;
calibrating, by the AP, a Molar mass of air at the AP based on the humidity associated with the AP and the temperature associated with the AP;
calibrating, by the AP, the temperature associated with the AP based on a temperature at sea level and the location of the AP; and
determining, by the AP, an altitude of the AP based on the calibrated gravitational acceleration at the AP, the calibrated Molar mass of air at the AP, the calibrated temperature associated with the AP, and the air pressure associated with the AP.

2. The method of claim 1, wherein calibrating the gravitational acceleration at the AP based on the gravitational acceleration on the equatorial surface and the location associated with the AP comprises:
extracting an altitude and a latitude of the AP from the location associated with the AP; and
determining the gravitational acceleration at the AP as the calibrated gravitational acceleration based on the altitude and the latitude of the AP, an average radius of the Earth, and the gravitational acceleration on the equatorial surface.

3. The method of claim 1, wherein calibrating the Molar mass of air at the AP based on the humidity associated with the AP and the temperature associated with the AP comprises:
obtaining a relative humidity (RH) associated with the AP;
determining a saturation vapor pressure associated with the AP based on the temperature associated with the AP;
determining an absolute humidity (AH) associated with the AP based on the RH associated with the AP, the temperature associated with the AP, and the saturation vapor pressure associated with the AP; and
determining the Molar mass of air at the AP as the calibrated Molar mass of air based on the AH associated with the AP.

4. The method of claim 1, wherein calibrating the temperature associated with the AP based on the temperature at the sea level and the location of the AP comprises:
determining the temperature associated with the AP as the calibrated temperature based on the calibrated gravitational acceleration, the calibrated Molar mass of air, and the air pressure associated with the AP.

5. The method of claim 1, wherein the AP is a first AP, and the method further comprises:
determining an altitude difference between the first AP and a second AP; and
dividing the first AP into an AP group based on the altitude difference.

6. The method of claim 5, wherein determining the altitude difference between the first AP and the second AP comprises:
determining the altitude difference between the first AP and the second AP based on the calibrated gravitational acceleration at the first AP, the calibrated Molar mass of air at the first AP, the calibrated temperature associated with the first AP, the air pressure associated with the first AP and an air pressure associated with the second AP; or
receiving the altitude difference between the first AP and the second AP via a user input.

7. The method of claim 5, wherein determining the altitude difference between the first AP and the second AP further comprises:
determining the altitude of the second AP based on the calibrated gravitational acceleration at the second AP, the calibrated Molar mass of air at the second AP, the calibrated temperature associated with the second AP, and the air pressure associated with the second AP;
determining the altitude of a third AP based on the calibrated gravitational acceleration at the third AP, the calibrated Molar mass of air at the third AP, the calibrated temperature associated with the third AP, and the air pressure associated with the third AP;
determining the altitude of a fourth AP based on the calibrated gravitational acceleration at the fourth AP, the calibrated Molar mass of air at the fourth AP, the calibrated temperature associated with the fourth AP, and the air pressure associated with the fourth AP;
determining a distance between the first AP and a plane comprising the second AP, the third AP, and fourth AP; and
determining the distance between the first AP and the plane as the altitude difference between the first AP and a second AP.

8. The method of claim 5, further comprising:
calibrating a temperature gradient at the first AP based on the calibrated gravitational acceleration at the first AP, the calibrated Molar mass of air at the first AP, the calibrated temperature associated with the first AP, the air pressure associated with the first AP, an air pressure associated with the second AP, and the altitude difference between the first AP and the second AP.

9. The method of claim 8, wherein calibrating the temperature gradient at the first AP comprises:
determining an object function for calibrating the temperature gradient at the first AP;
determining a derivative equation of the object function; and
determining a solution of the derivative equation of the object function as the calibrated temperature gradient.

10. The method of claim 5, wherein dividing the first AP into the AP group based on the altitude difference comprises:
in response to the altitude difference being greater than a threshold, dividing the first AP into a first AP group, wherein the second AP belongs to a second AP group different than the first AP group; or
in response to the altitude difference being less than the threshold, dividing the first AP into a same AP group with the second AP.

11. The method of claim 5, further comprising at least one of the following:
calibrating a temperature gradient for determining the altitude of the first AP based on a trained machine learning (ML) model; or
calibrating a gas constant for determining the altitude of the first AP based on the trained ML model.

12. The method of claim 11, wherein input features of the trained ML model are air pressures and temperatures, and an output feature of the trained ML model is altitudes, and the trained ML model is a supervised ML model.

13. The method of claim 11, further comprising:
in response to the input features and the output feature being linear, using a linear regression model to calibrate at least one of the temperature gradient or the gas constant.

14. The method of claim 12, further comprising:
in response to the input features and the output feature being non-linear, using a non-linear regression model to calibrate at least one of the temperature gradient or the gas constant.

15. The method of claim 14, further comprising:
in response to an accuracy of the at least one of the temperature gradient or the gas constant being less than an requirement, calibrating the at least one of the temperature gradient or the gas constant using at least one neutral networks (NNs).

16. The method of claim 14, wherein the linear regression model comprises one of the following:
a polynomial regression model;
a support vector regression (SVR) model;
a decision tree model; or
an NN model.

17. An access point (AP) comprising:
at least one processor; and
a memory coupled to the at least one processor, the memory storing instructions to cause the at least one processor to:
obtain an air pressure associated with the AP, a location associated with the AP, a temperature associated with the AP, and a humidity associated with the AP;
calibrate a gravitational acceleration at the AP based on a gravitational acceleration on an equatorial surface and the location associated with the AP;
calibrate a Molar mass of air at the AP based on the humidity associated with the AP and the temperature associated with the AP;
calibrate the temperature associated with the AP based on a temperature at sea level and the location of the AP; and
determine an altitude of the AP based on the calibrated gravitational acceleration at the AP, the calibrated Molar mass of air at the AP, the calibrated temperature associated with the AP, and the air pressure associated with the AP.

18. The AP of claim 17, wherein the instructions calibrate the gravitational acceleration at the AP based on the gravitational acceleration on the equatorial surface and the location associated with the AP comprises instructions to cause the at least one processor to:
extract an altitude and a latitude of the AP from the location associated with the AP; and
determine the gravitational acceleration at the AP as the calibrated gravitational acceleration based on the altitude and the latitude of the AP, an average radius of the Earth, and the gravitational acceleration on the equatorial surface.

19. The AP of claim 17, wherein the instructions to calibrate the Molar mass of air at the AP based on the humidity associated with the AP and the temperature associated with the AP comprise instructions to cause the at least one processor to:
obtain a relative humidity (RH) associated with the AP;
determine a saturation vapor pressure associated with the AP based on the temperature associated with the AP;
determine an absolute humidity (AH) associated with the AP based on the RH associated with the AP, temperature associated with the AP, and the saturation vapor pressure associated with the AP; and
determine the Molar mass of air at the AP as the calibrated Molar mass of air based on the AH associated with the AP.

20. A non-transitory computer-readable medium comprising instructions stored thereon which, when executed by an access point (AP), cause the AP to:
obtain an air pressure associated with the AP, a location associated with the AP, a temperature associated with the AP, and a humidity associated with the AP;
calibrate a gravitational acceleration at the AP based on a gravitational acceleration on an equatorial surface and the location associated with the AP;
calibrate a Molar mass of air at the AP based on the humidity associated with the AP and the temperature associated with the AP;
calibrate the temperature associated with the AP based on a temperature at sea level and the location of the AP; and
determine an altitude of the AP based on the calibrated gravitational acceleration at the AP, the calibrated Molar mass of air at the AP, the calibrated temperature associated with the AP, and the air pressure associated with the AP.
